(19) United States
(12) Patent Application Publication
(10) Pub. No.: US 2019/0289445 A1
(43) Pub. Date: Sep. 19, 2019

(54) WIRELESS RADIO USER EQUIPMENT AS LOCAL MANAGER FOR INTEGRATING ACCESS BACKHAUL AND SIDELINK

(71) Applicant: AT&T Intellectual Property I, L.P., Atlanta, GA (US)

(72) Inventors: Xiaoyi Wang, Austin, TX (US); Thomas Novlan, Austin, TX (US); Milap Majmundar, Austin, TX (US); Arunabha Ghosh, Austin, TX (US); Andrew Thornburg, Austin, TX (US)

(21) Appl. No.: 15/923,958

(22) Filed: Mar. 16, 2018

(51) Int. Cl. H04W 4/40; H04W 8/22; H04W 24/10

(52) U.S. Cl. CPC H04W 4/40; H04W 84/20; H04W 24/10; H04W 8/22

(57) ABSTRACT

The described technology is generally directed towards operating a user equipment as a local manager to manage/relay data from other access user equipment(s). Selection of a user equipment as a manager can be based on user equipment capability information and a reference signals report. If selected, the user equipment is instructed to operate as a local manager, including receiving local manager data from the network for use by the user equipment in operating as the local manager, such as which access user equipments to manage, and assigned radio resource pool for scheduling the access user equipment. The use of a local manager allows a semi-autonomous spectrum utilization technology that integrates the access, backhaul and sidelink in a unified framework.

### TECHNICAL FIELD

The subject application is related to wireless communication systems, and, for example, to a unified approach for mobile relays and vehicle-to-everything (V2X) communications.

### BACKGROUND

In LTE wireless communication systems, vehicle-to-everything (V2X) generally utilizes the Sidelink interface, alternatively referred to as PC5, to enable V2X communications, including V2V (vehicle-to-vehicle) communications, V21 (vehicle-to-infrastructure) communications, V2P (vehicle-to-pedestrian) communications and V2N (vehicle-to-network) communications. The PC5 interface is built based on a mesh architecture of peer-to-peer device communication. LTE V2X also supports Uu interface (the radio interface between the mobile device and the radio access network) enhancement to assist the PC5 communications.

Existing (e.g., PC5-based) interfaces assume a mesh architecture in which every node is a peer to each other. This approach does not rely on any network infrastructure. However, spectrum efficiency cannot be very high because of the peer-to-peer structure. Another drawback of this mesh architecture is that it is not compatible with infrastructure-based cellular networks that utilize a hierarchical architecture. As a result, a separate spectrum needs to be obtained to deploy a V2X service based on a peer-to-peer mesh network architecture, which is very costly.

### BRIEF DESCRIPTION OF THE DRAWINGS

The technology described herein is illustrated by way of example and not limited in the accompanying figures in which like reference numerals indicate similar elements and in which:

FIG. 1 illustrates an example wireless communication system in which a network node device (e.g., network device) and various user equipment (UE), including a UE operating as a local manager, can implement various aspects and implementations of the subject disclosure.

FIG. 2 illustrates an example communications sequence including communications to operate a user equipment as a local manager, in accordance with various aspects and implementations of the subject disclosure.

FIG. 3 illustrates an example communications sequence including communications to cease operating a user equipment as a local manager, in accordance with various aspects and implementations of the subject disclosure.

FIGS. 4-6 comprise an example flow diagram of operations of a network device for communicating with a user equipment, including communications to operate the user equipment as a local manager, in accordance with various aspects and implementations of the subject disclosure.

FIGS. 7 and 8 comprise an example flow diagram of operations of a user as the claim equipment that can operate as a local manager, in accordance with various aspects and implementations of the subject disclosure.

FIG. 9 illustrates an example flow diagram of network device operations for indicating from the network device to a user equipment to operate as a local manager, in accordance with various aspects and implementations of the subject disclosure.

FIG. 10 illustrates a block diagram of a user equipment's example operations, comprising operations for operating the user equipment as a local manager, in accordance with various aspects and implementations of the subject disclosure.

FIG. 11 illustrates an example flow diagram of network device operations for indicating from the network device to a user equipment to operate as a local manager, in accordance with various aspects and implementations of the subject disclosure.

FIG. 12 illustrates an example block diagram of an example mobile handset operable to engage in a system architecture that facilitates wireless communications according to one or more embodiments described herein.

FIG. 13 illustrates an example block diagram of an example computer operable to engage in a system architecture that facilitates wireless communications according to one or more embodiments described herein.

### DETAILED DESCRIPTION

Briefly, one or more aspects of the technology described herein are generally directed towards a semi-autonomous spectrum utilization concept that integrates Access, Backhaul and Sidelink links together under a common framework. In one or more aspects, the integration is accomplished by promoting (at least temporarily) a user equipment to operate as a local manager with respect to other access user equipment(s). Note that as used herein, “local” means that this user equipment/local manager node is granted a radio resource pool for a local area. The network can restrict the transmission power to ensure that the coverage from a local manager is only for a specific area; (in comparison to “global”, local means the network may grant the same radio resources to another local manager that has a different geographical area).

More particularly, the technology generally operates to promote a user equipment (which may be a particular type of user equipment such as in a vehicle or road-side unit) to be a local manager (which alternatively may be referred to as a V2X relay). A local manager can provide access to user equipments (such as a primary or secondary cell) in a standalone or non-standalone network deployment. For example, a local manager can schedule user equipments over a Sidelink interface with radio resources from a resource pool granted by the network, while maintaining a hierarchical network architecture that can be used in conjunction with infrastructure-based Integrated Access and Backhaul (IAB) deployments; (3GPP is developing a relaying solution where the user access and backhaul links use the same air interface).

Note that because the IAB design reuses the new radio access link for backhauling, the IAB relaying solution is designed for a hierarchical network design, rather than a traditional peer-to-peer mesh network. To overcome the challenge of supporting mobile relays (especially at high frequencies where access devices would be performing frequent handovers when traveling at high speed), the technology described herein recognizes the advantages of supporting a Sidelink framework in which devices can communicate with nearby vehicles, reducing latency and reducing interruptions. Note further that another concept in LTE V2X is to have a road side unit facilitate the vehicle communication, which can help to collect data from surrounding vehicles and then distribute the raw or processed information back to the network. In addition, IAB makes it possible to dynamically share air interface resources between user access and backhaul links in response to traffic and network conditions. The technology described herein provides an efficient unified framework for mobile relays and V2X, e.g. Integrated Access, Backhaul, and Sidelink (IABS).

It should be understood that any of the examples and terms used herein are non-limiting. For instance, the examples are based on New Radio (NR, sometimes referred to as 5G) communications between a user equipment exemplified as a smartphone or the like and network device; however virtually any communications devices may benefit from the technology described herein, and/or their use in different spectrums may likewise benefit. Notwithstanding, these are non-limiting examples, and any of the embodiments, aspects, concepts, structures, functionalities or examples described herein are non-limiting, and the technology may be used in various ways that provide benefits and advantages in radio communications in general.

In some embodiments the non-limiting term “radio network node” or simply “network node,” “radio network device or simply “network device” is used herein. These terms may be used interchangeably, and refer to any type of network node that serves user equipment and/or connected to other network node or network element or any radio node from where user equipment receives signal. Examples of radio network nodes are Node B, base station (BS), multi-standard radio (MSR) node such as MSR BS, gNodeB, eNode B, network controller, radio network controller (RNC), base station controller (BSC), relay, donor node controlling relay, base transceiver station (BTS), access point (AP), transmission points, transmission nodes, RRU, RRH, nodes in distributed antenna system (DAS) etc.

In some embodiments the non-limiting term user equipment (UE) is used. It refers to any type of wireless device that communicates with a radio network node in a cellular or mobile communication system. Examples of user equipment are target device, device to device (D2D) user equipment, machine type user equipment or user equipment capable of machine to machine (M2M) communication, PDA, Tablet, mobile terminals, smart phone, laptop embedded equipped (LEE), laptop mounted equipment (LME), USB dongles etc.

Some embodiments are described in particular for 5G new radio systems. The embodiments are however applicable to any radio access technology (RAT) or multi-RAT system where the user equipment operates using multiple carriers e.g. LTE FDD/TDD, WCMDA/HSPA, GSM/GERAN, Wi Fi, WLAN, WiMax, CDMA2000 etc.

The embodiments are applicable to single carrier as well as to multicarrier (MC) or carrier aggregation (CA) operation of the user equipment. The term carrier aggregation (CA) is also called (e.g. interchangeably called) “multi-carrier system”, “multi-cell operation”, “multi-carrier operation”, “multi-carrier” transmission and/or reception.

Note that the solutions outlined equally applies for Multi RAB (radio bearers) on some carriers (that is data plus speech is simultaneously scheduled).

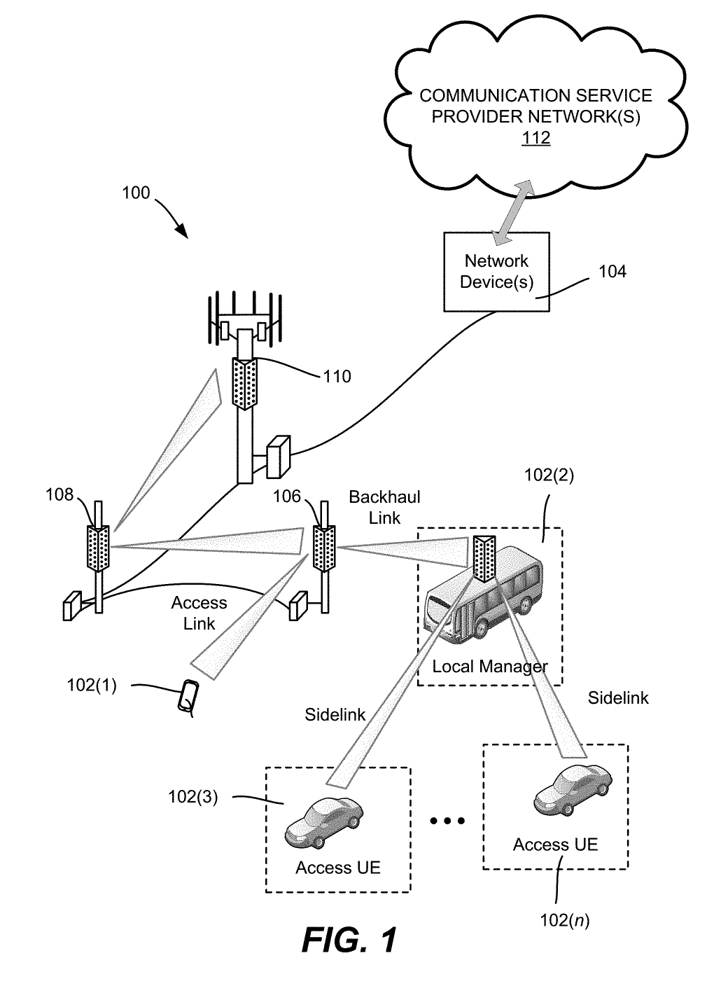

FIG. 1 illustrates an example wireless communication system 100 in accordance with various aspects and embodiments of the subject technology. In general, and as will be understood, the wireless communication system 100 provides for integrated Access, Backhaul, and Sidelink links.

In one or more embodiments, the system 100 can comprise one or more user equipments 102(1)-102(n), including at least one user equipment (e.g., 102(2)) that operates as a local manager. In the example shown, a user equipment (e.g., a smartphone 102(1)) couples to the network 104 (e.g., any network device or devices) via an Access link to an antenna 106. The local manager 102(2), e.g., implemented within user equipment present in a bus-type vehicle, communicates with the network 104, including through the antenna 106 via a Backhaul link. Further, access user equipments 102(3)-102(n) (e.g., in car-type vehicles) communicates with the network 104, via the local manager (user equipment 102(2)) has described herein.

In various embodiments, the system 100 is or comprises a wireless communication network serviced by one or more wireless communication network providers. In example embodiments, a user equipment (collectively or individually 102) can be communicatively coupled to the wireless communication network via a network device 104 (e.g., network node). The network device 104 can communicate with the user equipment (UE) 102, thus providing connectivity between the user equipment and the wider cellular network.

In example implementations, each user equipment 102 such as the user equipment 102(1) is able to send and/or receive communication data via a wireless link to the network device 104. The system 100 can thus include one or more communication service provider networks 112 that facilitate providing wireless communication services to various user equipment, including user equipments 102(1)-102(n), via the network device 104 and/or various additional network devices (not shown) included in the one or more communication service provider networks 112. The one or more communication service provider networks 112 can include various types of disparate networks, including but not limited to: cellular networks, femto networks, picocell networks, microcell networks, internet protocol (IP) networks Wi-Fi service networks, broadband service network, enterprise networks, cloud based networks, and the like. For example, in at least one implementation, system 100 can be or include a large scale wireless communication network that spans various geographic areas. According to this implementation, the one or more communication service provider networks 106 can be or include the wireless communication network and/or various additional devices and components of the wireless communication network (e.g., additional network devices and cell, additional user equipments, network server devices, etc.).

The network device 104 can be connected to the one or more communication service provider networks 112 via one or more backhaul links or the like. For example, the one or more backhaul links can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 108 can also include wireless link components, such as but not limited to, line-of-sight (LOS) or non-LOS links which can include terrestrial air-interfaces or deep space links (e.g., satellite communication links for navigation).

The wireless communication system 100 can employ various cellular systems, technologies, and modulation schemes to facilitate wireless radio communications between devices (e.g., the user equipment 102 and the network device 104). While example embodiments might be described for 5G new radio (NR) systems, the embodiments can be applicable to any radio access technology (RAT) or multi-RAT system where the user equipment operates using multiple carriers e.g. LTE FDD/TDD, GSM/GERAN, CDMA2000 etc. For example, the system 100 can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000,time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system 100 are particularly described wherein the devices (e.g., the user equipments 102 and the network device 104) of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the user equipment. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system 100 can be configured to provide and employ 5G wireless networking features and functionalities. With 5G networks that may use waveforms that split the bandwidth into several sub bands, different types of services can be accommodated in different sub bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

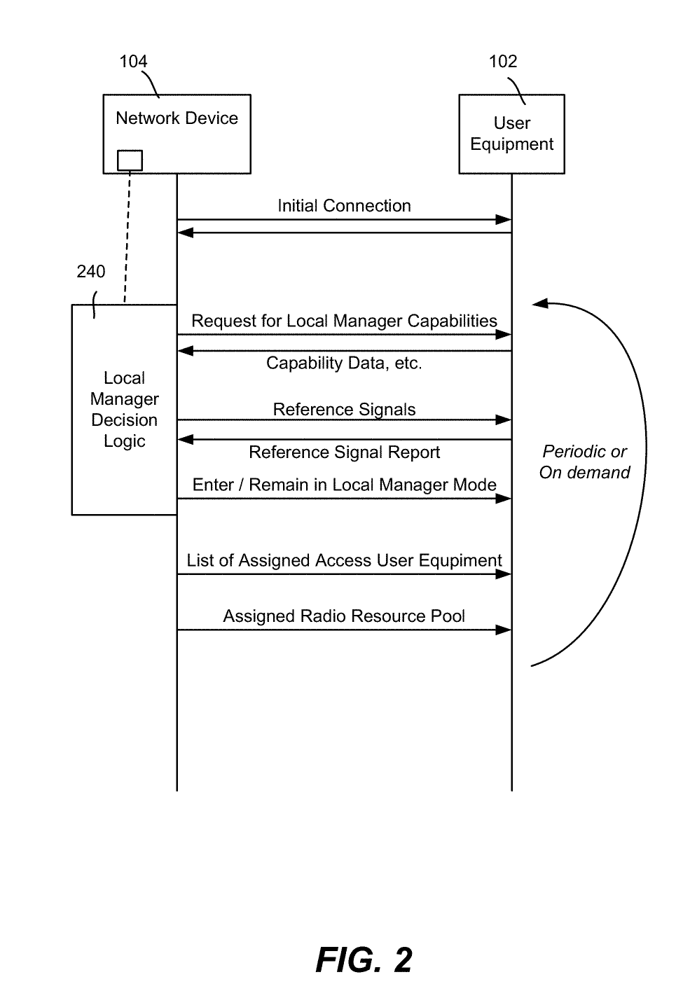

Turning to aspects related to the use of a local manager to provide integrated Access, Backhaul, and Sidelink links, FIG. 2 shows an example sequence of communications and operations that describe one suitable procedure for establishing a local manager, along with a general description of how a local manager works. As generally represented in the example of FIG. 2, a user equipment connects to the network (to an appropriate network device) by way of a regular initial access procedure (e.g., via the Access link).

Once connected, in keeping with the technology described herein, the user equipment reports its capability to the network device to indicate whether that user equipment can be a local manager. Note that FIG. 2 includes a communication from the network device to the user equipment requesting the local manager capability data; however this request need not be explicit, but can be implicit following a connection between the network device and the user equipment.

Non-limiting examples of reported capability data provided by the user equipment can comprise a set of processing capabilities/radio frequency capabilities, such as including a maximum number of user equipments that can be supported by the user equipment if operating as a local manager. Other reported capability data may comprise power metrics/battery metrics of the user equipment, the current (and/or possibly anticipated) speed/trajectory data of the user equipment, service availability (e.g., local V2X server), or user equipment type (e.g., whether he device is coupled to or present in a bus, drone, car, etc.). In general, the capability data is directed to whether or not the user equipment will be adequate if serving as a local manager; for example, it is relevant that the user equipment has sufficient power and battery life, is not moving too fast, and so on. The type of user equipment can be relevant, e.g., whether the user equipment is coupled to a vehicle battery or is using an internal battery can be a deciding factor.

The network device 104 generates (or causes to be generated) reference signals. As further represented in FIG. 2, the network device 104 instructs the user equipment 102 to measure a list of reference signal to detect the local propagation and interference environments.

As represented in FIG. 2, local manager decision logic 240 evaluates the capability data and reference signal report to determine whether the user equipment is suitable for operating as a local manager. If this particular user equipment 102 is suitable to become a local manager, the network indicates to (instructs) the user equipment to enter local manager mode. Criteria for selecting a local manager can be based on one or more criteria such as measurements, hardware capability (e.g. integrated with a vehicle vs. battery powered), service availability (e.g. self-driving or other V2X service), QoS indication, or user preference (e.g. multi-device hub).

FIG. 2 represents the scenario in which the network device 104 selects the user equipment 102 to be a local manager. Note that the communication in which the network device instructs these equipment to operate as a local manager can occur at any time following a periodic or on demand request for capability data and a reference signals report. A user equipment 102 already operating as a local manager can requalify in this way, and thus the communication can be to remain in the local manager mode, (although such a communication maybe inherent, e.g., once operating as a local manager, continue operating as one until otherwise notified).

As part of operating as a local manager, the network device 104 sends data to the user equipment 102, including a list of assigned access user equipment(s) that the local manager will manage. In other words, the network device 104 signals a list of user equipment assigned to this local manager. In one example, the network may determine the list of user equipments to be connected to the local manager based on one or more criteria such as RSRP/RSSI (Reference Signal Received Power/Received Signal Strength Indicator (RSSI)) measurements, positioning/proximity information (absolute or relative), traffic type (e.g. local V2X messages), traffic load, etc.

Has also shown and FIG. 2, the network device 104 assigns a radio resource pool to the local manager for scheduling the access user equipment. The radio resource pool may correspond to a set of time/frequency downlink and/or uplink resources, which can be by in-band (shared or partially shared) or out-of-band (orthogonal) with respect to the resources utilized by the cellular network. The resource pool may be orthogonal or partially overlapping with the resource pools of other local managers.

Although FIG. 2 is directed to a single user equipment becoming a local manager, a network may intentionally promote more than one user equipment to operate as a local manager, such as based on multiple criteria. For example, one local manager can be set up to serve a certain type and/or QoS of traffic in orthogonal set of resource pools, compared to another local manager. Such a decision can be driven by criteria such as processing power, memory limitations, and so one of each local manager, volume, type or QoS requirements of traffic expected to be handled by each local manager, etc.

Among the communications, e.g., as part of the capability data or as a separate communication, a user equipment may request the network device to promote the user equipment to be a local manager. For example, a user equipment that is in good network coverage may receive peer-to-peer broadcast messages requesting network connectivity from other user equipments that are out of network coverage. Depending upon its own conditions (e.g. user equipment capability, battery power, processing power, available memory, etc.), the user equipment with good network coverage may request the network to promote it to a local manager for the user equipment(s) that are out of coverage. Note that without such a request, the network device may be unable to determine the need to promote such a user equipment to local manager, e.g., because the network device is not connected with the pool of out of coverage user equipment(s). If multiple user equipments generate competing requests to serve as a local manager, the network can select the user equipment most suitable to serve as local manager based on criteria such as the selection criteria listed above.

According to traffic type, the local manager may forward the traffic received from an assigned user equipment back to the network (acting as traditional IAB node/relay), or may locally route the data and directly broadcast or unicast the traffic to other access user equipments. Thus, a significant amount of network communications can be avoided by the direct communications between the local manager and its assigned access user equipments. As is understood, depending on traffic type, the local manager can operate in a relay mode or in a local breakout mode based on traffic type information; the local breakout mode can route the data packet sent to the local manager from one access user equipment to another access user equipment; (that is, in the local breakout mode the data packet does not go through the core network).

In general, the local manager continues communicating with the network as a backhaul link. Local manager keeps monitoring the control channel from network If scheduled by the network, the local manager can transmit or receive its own data from network as signaled. The Backhaul link can be used to carry various types of network traffic including, but not limited to, signaling from network to local manager, status reports, e.g., CSI, traffic load, from local manager to network, data packet(s) from the application layer of the local manager (acting as regular user equipment) and data packet(s) received from access user equipment to network (as a regular relay node).

The local manager the service as a relay node to the access user equipment(s) (Sidelink) assigned by the network. The local manager can decide to schedule radio resource (from the pool granted by network) to the access user equipment(s). In one example the scheduling is based on the same downlink or uplink physical channels as used by regular access or backhaul links. In another example, the physical channels used for this Sidelink communication is based on a different physical channel/signals or enhancements of existing channels optimized for V2V/V2P links.

In general, each access user equipment sees the local manager as a regular base-station; therefore, the axis user equipment keep in synchronization with the local manager, monitors the control channel from the local manager and transmits/receives data from the local manager. In the case of dual connectivity (EN-DC or NR-NR DC), the local manager may only relay data messages and secondary node configuration signaling, while control signaling and mobility management are provided by the master cell (LTE or NR).

The network may directly switch the connection of access user equipments from an infrastructure node to a local manager through a mobility mechanism such as handover or SCG change (in case of dual connectivity). In another example the access user equipment may autonomously switch to being served by a local manager based on a network configurable criteria (e.g. RSRP threshold, proximity trigger, user/application selection).

The local manager may be connected to infrastructure-based IAB nodes as well as gNBs with direct fiber connection to the core network. In this case, the local manager can be configured as a mobile IAB node with an assigned hop order (e.g. # of links from the donor gNB with a fiber connection) with corresponding RRM/resource allocation partitions, routing tables, and topology management parameters.

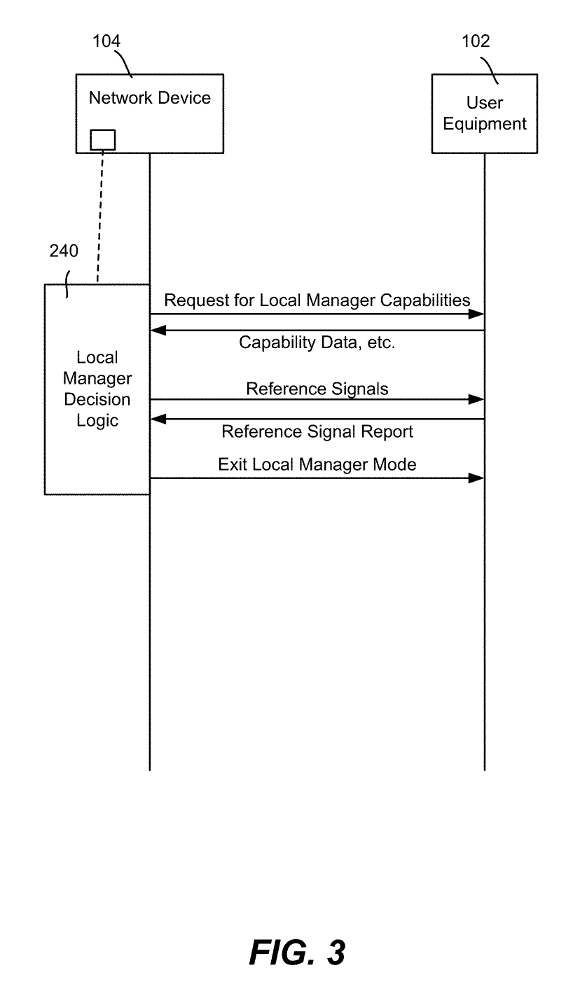

As represented in FIG. 3, at any appropriate time (e.g., following an update to the capability data and/or reference signals report) the network device 104 may demote the local manager so as to operate as a regular user equipment. For example, the network device 104 can send a communication to the user equipment 102 to exit the local manager mode. In deciding to demote, the network device 104 (e.g. the local manager decision logic 240) may use one or more demotion-related criteria, such as expiration of a network configurable timer, measurement threshold, positioning/proximity indication, QoS/QoE metric, traffic load, or user/application indication.

The network device 104 indicates to the other access user equipments served by the local manager to switch back to a regular base-station (e.g. via handover or reconfiguration of the Scell/SCG). The network device 104 revokes the resource pool granted to the (to-be-former) local manager, and indicates that the local manager is to go back to its regular user equipment mode and establish an access link to a regular base-station. Note that a local manager may request the network to demote itself based on any number of criteria, including battery status, device temperature, application request, processor/memory needs of local manager, etc.

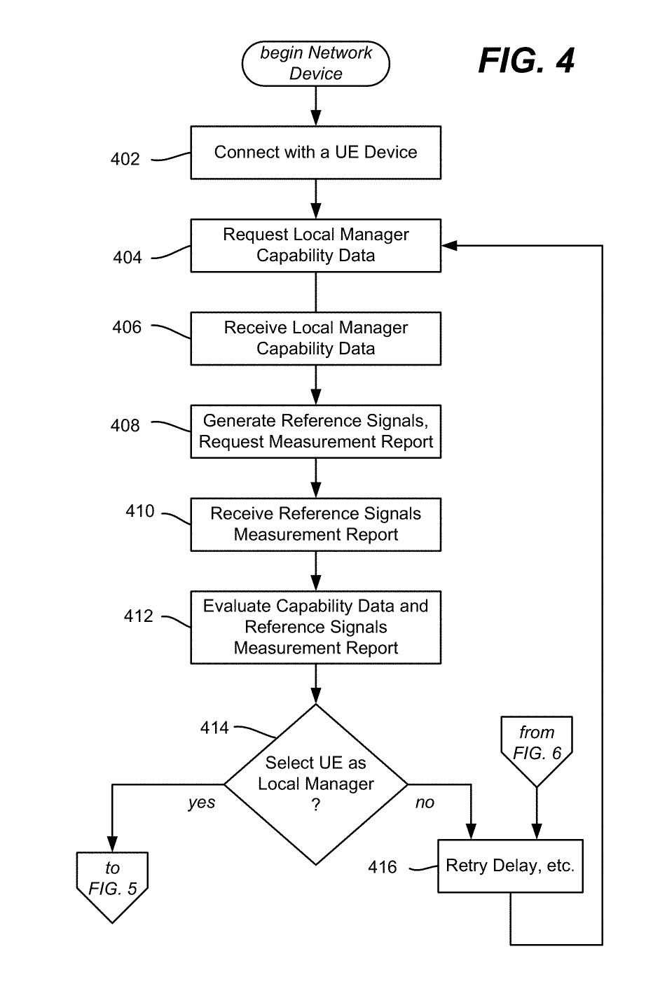

FIGS. 4-6 comprise a flow diagram showing some example operations that a network device may perform with respect to selecting (and de-selecting) a user equipment (UE) to operate as a local manager. Operation 402 represents connecting with a user equipment device.

After connecting, operation 404 represents requesting the local manager capability data from the user equipment, which are received at operation 406. Note that as set forth above, this request may be an explicit request, part of the initial connection protocol, or an inherent request following connection.

Operation 408 represents generating (or causing to be generated) reference signals, and requesting a measurement report or the like with respect to those reference signals. Again, the request maybe inherent, in that it is expected for the user equipment to report the reference signal measurements without asking for them. The report or the like is received at operation 410. Note that at least some of the operations depicted in the flow diagram(s) may occur in a different order from that shown; for example, if an explicit request for local manager capability data is made (operation 404), an explicit request for the reference signals measurement (operation 408) can be made before the local capability data is received (operation 406), and so on.

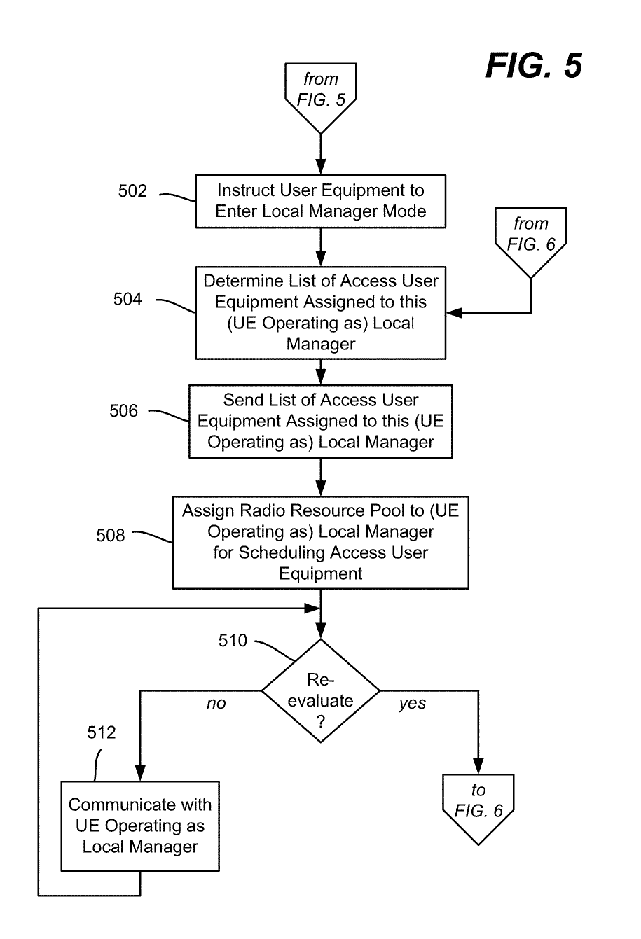

Operation 412 represents evaluating the capability data and the reference signals measurement report. Based on this evaluation, which may include a comparison with one or more other user equipments' capability data and reference signals measurement reports, operation 414 determines whether to select this user equipment as a local manager. If not, operation 416 represents retrying at some appropriate time, e.g. periodically or on demand, such as after some delay. If instead the user equipment is selected as a local manager, the process continues with the operations generally are exemplified in FIG. 5.

Operation 502 of FIG. 5 represents the instruction from the network device to the user equipment to enter the local manager mode. Operation 504 represents the network device determining the list of access user equipment to be assigned to this local manager, with operation 506 sending the list. Operation 508 represents assigning the radio resource pool to the local manager for scheduling the access user equipment assigned thereto.

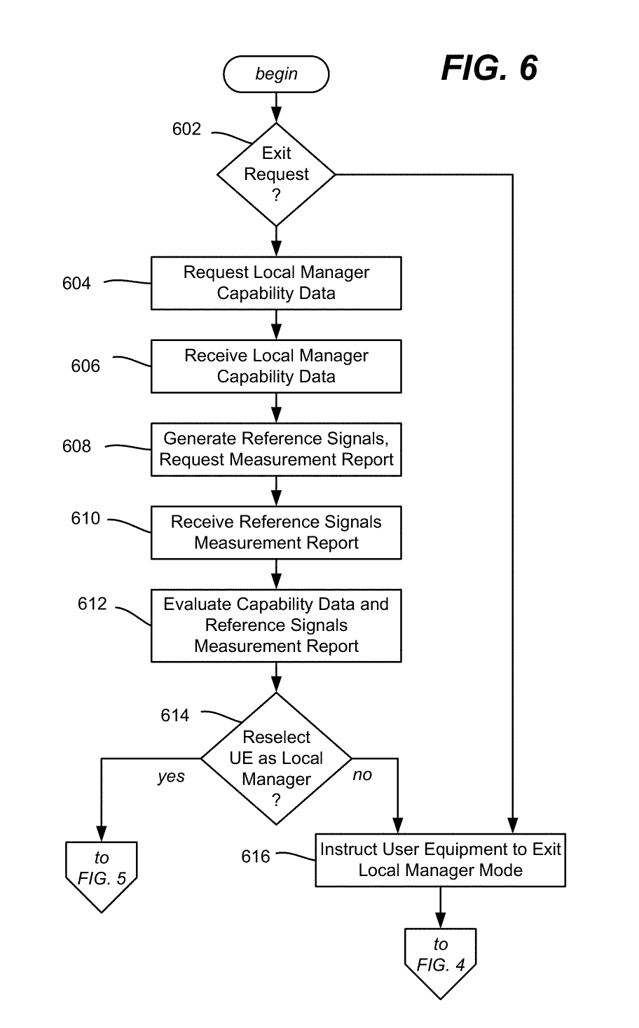

Operation 510 represents determining whether a reevaluation of the local manager's status is needed. This may be time based or based on some changed criterion/criteria such as a change to the user equipment location, another user equipment being considered for selection as a local manager, and so on. If a revaluation is not (yet) needed, operation 512 is performed which represents communicating with the user equipment operating as a local manager. If a reevaluation is needed, operation 510 branches to the operations generally exemplified in FIG. 6.

Operation 602 represents determining whether the user equipment (operating as a local manager) has explicitly requested to stop operating as a local manager. If so, operation 602 branches to operation 614 where an instruction for the user equipment to exit the local manager mode is made. Note that operation 614 may occur after some delay, e.g., to reassign/hand off access user equipments previously assigned to this local manager, and so on.

If not an explosive exit request, operation 604 represents requesting the local manager capability data of the user equipment, as this tends to change over time. Basically, operations 606, 608, 610, and 612 correspond to operations 406, 408, 410 and 412 described above with reference to FIG. 4, and are not described again here in for purposes of brevity. Operation 614 represents the network device deciding whether to reselect (retain) this user equipment as a local manager. If so, operation 614 returns to operation 504 of FIG. 5; (because the access user equipment assigned thereto may need to be changed, and so on). One

If the network device decides to no reselect (retain) this user equipment as a local manager, operation 616 is performed which instructs the user equipment exit a local manager mode. Operation 616 also includes communications needed for the user equipment to operate as conventional user equipment instead of a local manager. The process returns to operation 416 of FIG. 4, which represents a later retry after some delay, status change, or the like.

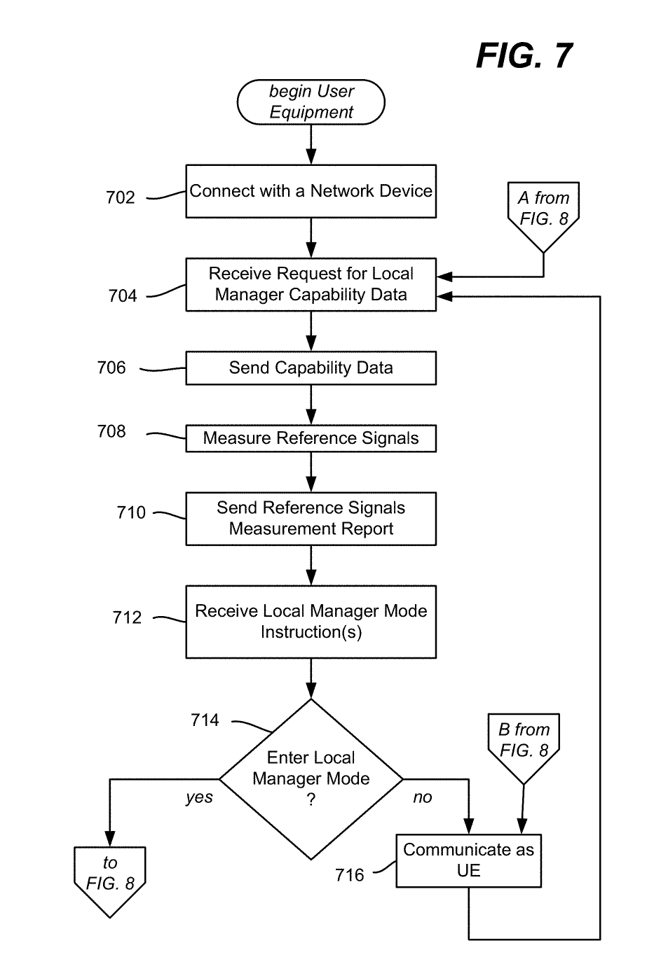

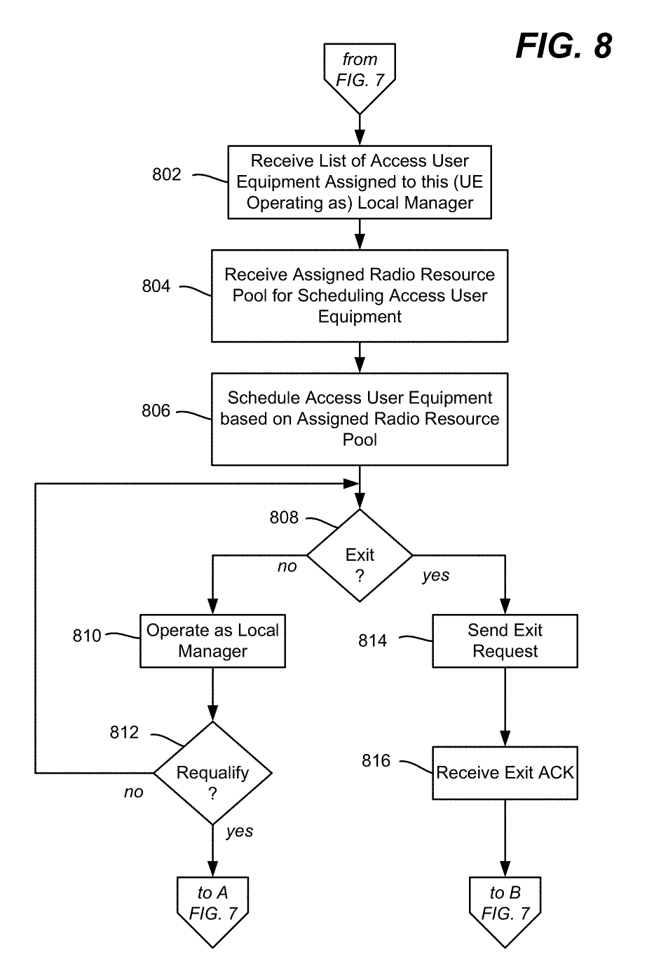

FIGS. 7 and 8 represent user equipment operations with respect to attempting/becoming a local manager. Operation 702 represents connecting with a network device has described herein.

After connecting, operation 704 represents receiving the request from the network device for the user equipment's local manager capability data, which the user equipment provides an operation 706. Operations 708 represents measuring the reference signals, with a measurement report sent at operation 710.

Operation 714 represents receiving local manager mode instructions. If the instruction is to enter the local manager mode, operation 714 branches to the operation since amplified in fig eight. Otherwise, at operation 716, the user equipment communicates/operates as a user equipment.

As part of operating as a local manager, operation 802 of FIG. 8 represents receiving the list of user access equipment assigned to this local manager, as described herein. Operation 804 represents receiving the assigned radio resource pool for scheduling the access user equipment has also described herein. Operation 806 represents scheduling the assigned access user equipment.

Operation as a local manager continues via operations 808, 810, and 812 until the local manager decides (operation 808) to exit the local manager mode has described herein or the user equipment needs to requalify (operation 812) to continue as a local manager. While operating as the local manager, the user equipment can act in a relay mode or a local breakout mode, depending on traffic type information, as described herein. If time to requalify, whether by on demand indication from the network device or periodic operation, operation 812 branches to entry point A in FIG. 7, that is, operation 704.

If at operation 808 an exit from the local manager mode is desired, operation 814 represents sending the exit request, with operation 816 representing (waiting for and) receiving an exit acknowledgment or the like. When it is appropriate to stop operating as a local manager, the user equipment returns to entry point B of FIG. 7, that is, operation 716 where the user equipment communicates in the user equipment mode.

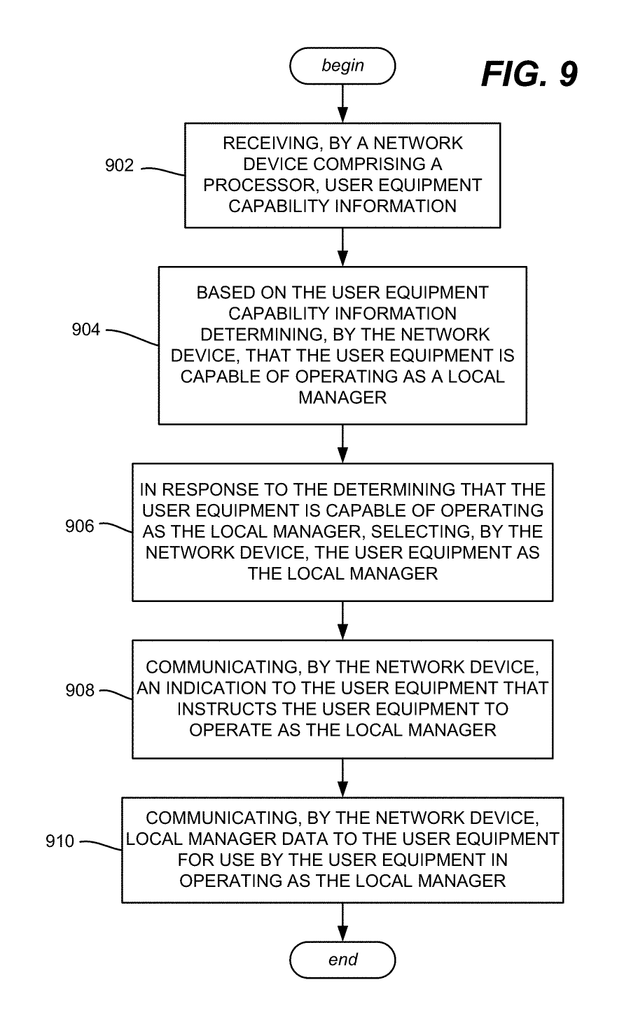

FIG. 9 represents general, example operations of a network device 104. Operation 902 represents receiving, by a network device comprising a processor, user equipment capability information. Based on the user equipment capability information, determining, by the network device, that the user equipment is capable of operating as a local manager, is represented as operation 904. In response to the determining that the user equipment is capable of operating as the local manager, operation 906 represents selecting, by the network device, the user equipment as the local manager. Operation 908 represents communicating, by the network device, an indication to the user equipment that instructs the user equipment to operate as the local manager. Operation 910 represents communicating, by the network device, local manager data to the user equipment for use by the user equipment in operating as the local manager.

Aspects can comprise instructing, by the network device, the user equipment to measure reference signal data resulting in measured reference signal data, and to return a report corresponding to the measured reference signal data; determining that the user equipment is capable of operating as the local manager further can comprise receiving the report at the network device, and evaluating the report by the network device.

Receiving the user equipment capability information can comprise receiving at least one of: processing capability data of the user equipment, radio frequency capability data of the user equipment, a number of other user equipment that can be supported by the user equipment when operating as the local manager, power data of the user equipment, battery data of the user equipment, speed data of the user equipment, trajectory data of the user equipment, service availability data of the user equipment, or type data of the user equipment.

Selecting the user equipment as the local manager can comprise evaluating a selection criterion, the selection criterion is evaluated based on at least one of: measurement data of the user equipment, a hardware capability of the user equipment, service availability data applicable to the user equipment, quality of service data applicable to user equipment, or user preference data.

Communicating the indication to the user equipment that instructs the user equipment to operate as the local manager can comprise instructing the user equipment to enter a local manager mode. Communicating the local manager data to the user equipment for use by the user equipment in operating as the local manager can comprise identifying an access user equipment assigned to the user equipment. Communicating the local manager data to the user equipment for use by the user equipment in operating as the local manager can comprise assigning a radio resource pool to the user equipment for scheduling an access user equipment.

Aspects can comprise receiving, by the network device, communications from the user equipment, which can comprise receiving a data packet from an access user equipment directed towards the network device, wherein the access user equipment is managed by the user equipment operating as the local manager.

Aspects can comprise communicating, by the network device, an indication to the user equipment that instructs the user equipment to no longer operate as the local manager.

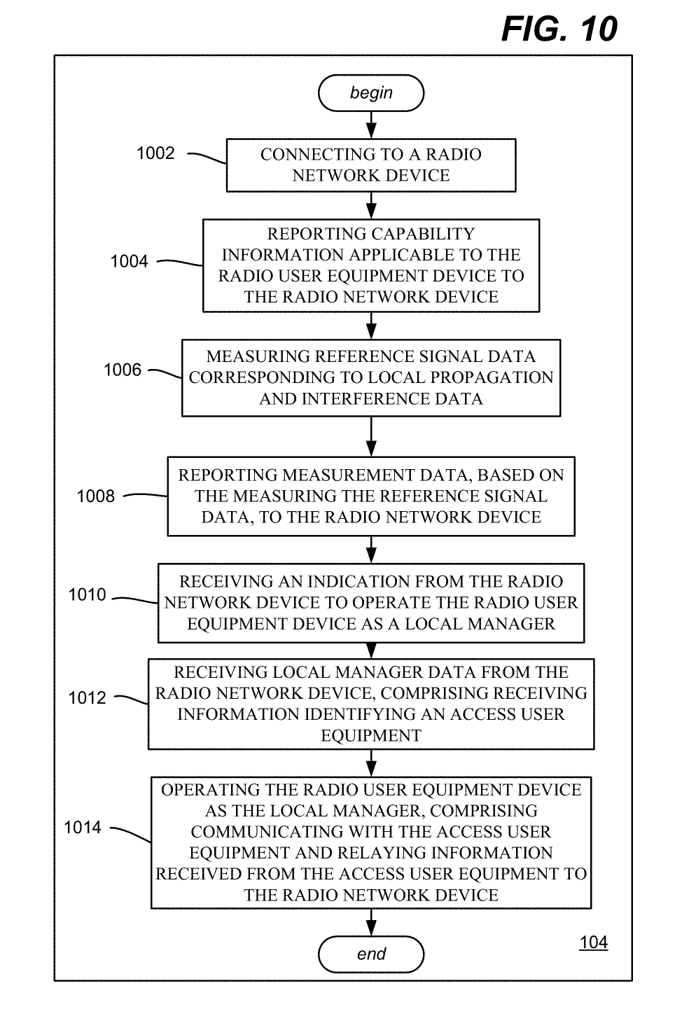

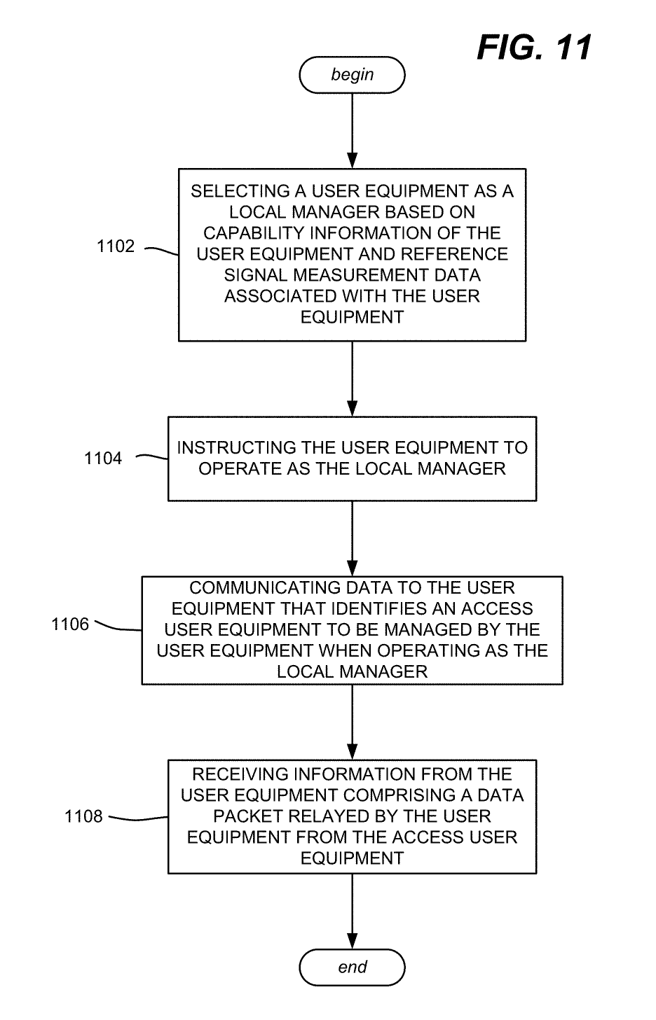

FIG. 10 represents general, example operations of a radio user equipment device 102, generally comprising a processor a memory that stores executable instructions that, when executed by the processor, facilitate performance of operations. Example operations can comprise connecting to a radio network device (operation 1002), reporting capability information applicable to the radio user equipment device to the radio network device (operation 1004) and measuring reference signal data corresponding to local propagation and interference data (operation 1006). Operation 1008 represents reporting measurement data, based on the measuring the reference signal data, to the radio network device. Operation 1010 represents receiving an indication from the radio network device to operate the radio user equipment device as a local manager. Operation 1012 represents receiving local manager data from the radio network device, comprising receiving information identifying an access user equipment. Operation 1014 represents operating the radio user equipment device as the local manager, comprising communicating with the access user equipment and relaying information received from the access user equipment to the radio network device.

Operating the radio user equipment device as the local manager can comprise broadcasting or unicasting data to the access user equipment. Operating the radio user equipment device as the local manager can comprise scheduling radio resources to the access user equipment.

Other operations can comprise receiving other local manager data from the radio network device other than the local manager data, which can comprise receiving other information identifying another identifier of a different access user equipment other than the access user equipment; operating the radio user equipment device as the local manager can comprise communicating with the other access user equipment.

Other operations can comprise relaying, based on a traffic type, by the user equipment operating as the local manager, one or more data packets between one access user equipment coupled to the user equipment operating as the local manager and another access user equipment coupled to the user equipment operating as the local manager. Other operations can comprise operating the user equipment operating as the local manager in a relay mode or a local breakout mode based on traffic type information. Other operations can comprise receiving an indication from the radio network device to no longer operate the user equipment as the local manager.

FIG. 10 represents general, example operations of a radio network device 104, generally comprising a processor a memory that stores executable instructions that, when executed by the processor, facilitate performance of operations. Example operations can comprise selecting a user equipment as a local manager based on capability information of the user equipment and reference signal measurement data associated with the user equipment (operation 1102) and instructing the user equipment to operate as the local manager (operation 1104). Operation 1106 represents communicating data to the user equipment that identifies an access user equipment to be managed by the user equipment when operating as the local manager. Operation 1108 represents receiving information from the user equipment comprising a data packet relayed by the user equipment from the access user equipment.

Selecting the user equipment as the local manager can comprise receiving, from the user equipment the capability information of the user equipment and the reference signal measurement data associated with the user equipment, receiving from, other user equipment other than the user equipment, other capability information of the other user equipment and other reference signal measurement data associated with the other user equipment, and evaluating the capability information of the user equipment, the reference signal measurement data associated with the user equipment, the other capability information of the other user equipment, and the other reference signal measurement data associated with the other user equipment, to select the local manager.

Communicating the data to the user equipment can comprise sending a list to the user equipment that identifies the access user equipment and at least one other access user equipment other than the access user equipment.

Further operations can comprise, assigning a radio resource pool to the user equipment for scheduling the access user equipment. Further operations can comprise communicating an indication to the user equipment to cease operating as the local manager. Further operations can comprise assigning a hop order to the local manager for communication of data to a core network device coupled to the radio network device.

As can be seen, by allowing a network to promote a user equipment (e.g., a certain type) to be a local manager, various advantages are achieved. Some advantages include allowing hardware sharing between a regular cellular network and the V2X or D2D (device-to-device) network. The same node can serve as a relay node for a cellular network as well as a V2X local manager. Further, by promoting a UE to operate as a local manager, the peer-to-peer mesh network is in general converted to a hierarchical architecture, because local manager can schedule resources for UEs that are served by it under a standalone or non-standalone network deployment. The spectral efficiency is much better than that of a fully mesh network, and allows greater network control of licensed spectrum. Still further, technology described herein allows the introduction of mobile relays with existing infrastructure-based IAB nodes under a common architecture and resource allocation framework. The technology allows spectrum sharing between regular cellular networks and V2X services; the same spectrum band may be reused by V2X service or regular cellular traffic. The technology thus provides for a semi-autonomous spectrum utilization technology that integrates Access, Backhaul and Sidelink in a unified framework.

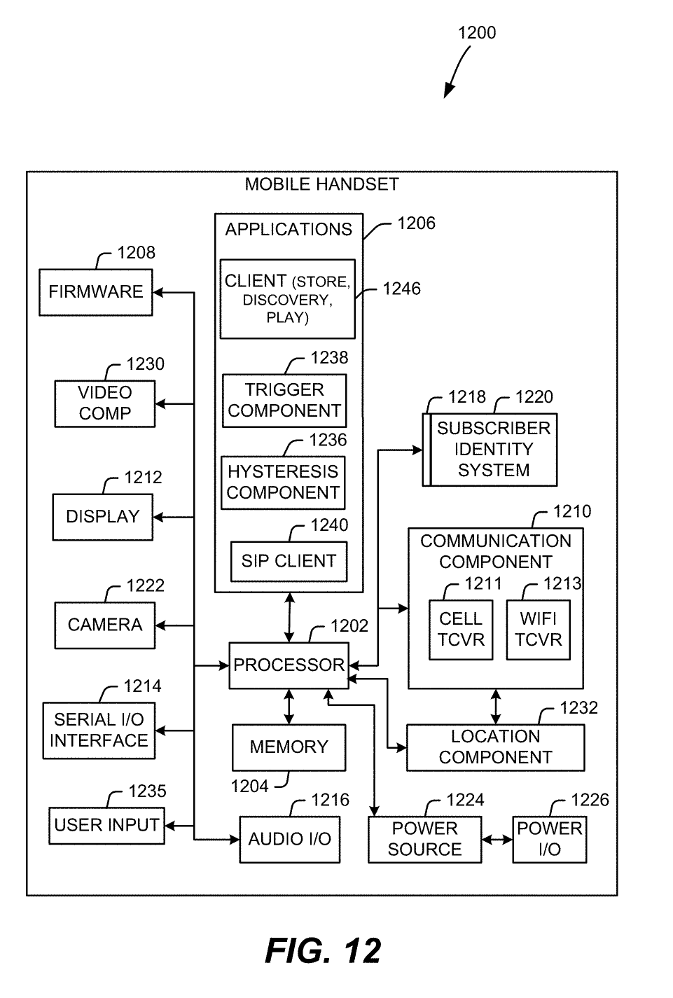

Referring now to FIG. 12, illustrated is an example block diagram of an example mobile handset 1200 operable to engage in a system architecture that facilitates wireless communications according to one or more embodiments described herein. Although a mobile handset is illustrated herein, it will be understood that other devices can be a mobile device, and that the mobile handset is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media

The handset includes a processor 1202 for controlling and processing all onboard operations and functions. A memory 1204 interfaces to the processor 1202 for storage of data and one or more applications 1206 (e.g., a video player software, user feedback component software, etc.). Other applications can include voice recognition of predetermined voice commands that facilitate initiation of the user feedback signals. The applications 1206 can be stored in the memory 1204 and/or in a firmware 1208, and executed by the processor 1202 from either or both the memory 1204 or/and the firmware 1208. The firmware 1208 can also store startup code for execution in initializing the handset 1200. A communications component 1210 interfaces to the processor 1202 to facilitate wired/wireless communication with external systems, e.g., cellular networks, VoIP networks, and so on. Here, the communications component 1210 can also include a suitable cellular transceiver 1211 (e.g., a GSM transceiver) and/or an unlicensed transceiver 1213 (e.g., Wi-Fi, WiMax) for corresponding signal communications. The handset 1200 can be a device such as a cellular telephone, a PDA with mobile communications capabilities, and messaging-centric devices. The communications component 1210 also facilitates communications reception from terrestrial radio networks (e.g., broadcast), digital satellite radio networks, and Internet-based radio services networks

The handset 1200 includes a display 1212 for displaying text, images, video, telephony functions (e.g., a Caller ID function), setup functions, and for user input. For example, the display 1212 can also be referred to as a “screen” that can accommodate the presentation of multimedia content (e.g., music metadata, messages, wallpaper, graphics, etc.). The display 1212 can also display videos and can facilitate the generation, editing and sharing of video quotes. A serial I/O interface 1214 is provided in communication with the processor 1202 to facilitate wired and/or wireless serial communications (e.g., USB, and/or IEEE 1294) through a hardwire connection, and other serial input devices (e.g., a keyboard, keypad, and mouse). This supports updating and troubleshooting the handset 1200, for example. Audio capabilities are provided with an audio I/O component 1216, which can include a speaker for the output of audio signals related to, for example, indication that the user pressed the proper key or key combination to initiate the user feedback signal. The audio I/O component 1216 also facilitates the input of audio signals through a microphone to record data and/or telephony voice data, and for inputting voice signals for telephone conversations.

The handset 1200 can include a slot interface 1218 for accommodating a SIC (Subscriber Identity Component) in the form factor of a card Subscriber Identity Module (SIM) or universal SIM 1220, and interfacing the SIM card 1220 with the processor 1202. However, it is to be appreciated that the SIM card 1220 can be manufactured into the handset 1200, and updated by downloading data and software.

The handset 1200 can process IP data traffic through the communications component 1210 to accommodate IP traffic from an IP network such as, for example, the Internet, a corporate intranet, a home network, a person area network, etc., through an ISP or broadband cable provider. Thus, VoIP traffic can be utilized by the handset 1200 and IP-based multimedia content can be received in either an encoded or a decoded format.

A video processing component 1222 (e.g., a camera) can be provided for decoding encoded multimedia content. The video processing component 1222 can aid in facilitating the generation, editing, and sharing of video quotes. The handset 1200 also includes a power source 1224 in the form of batteries and/or an AC power subsystem, which power source 1224 can interface to an external power system or charging equipment (not shown) by a power I/O component 1226.

The handset 1200 can also include a video component 1230 for processing video content received and, for recording and transmitting video content. For example, the video component 1230 can facilitate the generation, editing and sharing of video quotes. A location tracking component 1232 facilitates geographically locating the handset 1200. As described hereinabove, this can occur when the user initiates the feedback signal automatically or manually. A user input component 1234 facilitates the user initiating the quality feedback signal. The user input component 1234 can also facilitate the generation, editing and sharing of video quotes. The user input component 1234 can include such conventional input device technologies such as a keypad, keyboard, mouse, stylus pen, and/or touch screen, for example.

Referring again to the applications 1206, a hysteresis component 1236 facilitates the analysis and processing of hysteresis data, which is utilized to determine when to associate with the access point. A software trigger component 1238 can be provided that facilitates triggering of the hysteresis component 1236 when the Wi-Fi transceiver 1213 detects the beacon of the access point. A SIP client 1240 enables the handset 1200 to support SIP protocols and register the subscriber with the SIP registrar server. The applications 1206 can also include a client 1242 that provides at least the capability of discovery, play and store of multimedia content, for example, music.

The handset 1200, as indicated above related to the communications component 1210, includes an indoor network radio transceiver 1213 (e.g., Wi-Fi transceiver). This function supports the indoor radio link, such as IEEE 802.11, for the dual-mode GSM handset 1200. The handset 1200 can accommodate at least satellite radio services through a handset that can combine wireless voice and digital radio chipsets into a single handheld device.

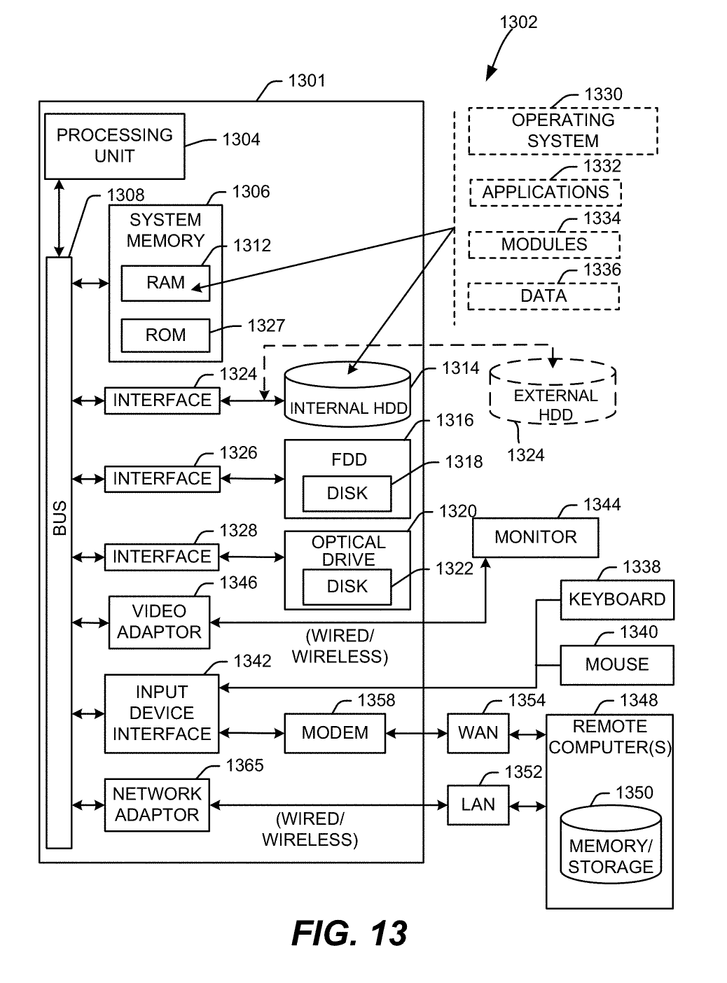

Referring now to FIG. 13, illustrated is an example block diagram of an example computer 1300 operable to engage in a system architecture that facilitates wireless communications according to one or more embodiments described herein. The computer 1300 can provide networking and communication capabilities between a wired or wireless communication network and a server (e.g., Microsoft server) and/or communication device. In order to provide additional context for various aspects thereof, FIG. 13 and the following discussion are intended to provide a brief, general description of a suitable computing environment in which the various aspects of the innovation can be implemented to facilitate the establishment of a transaction between an entity and a third party. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules, or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The techniques described herein can be applied to any device or set of devices (machines) capable of running programs and processes. It can be understood, therefore, that servers including physical and/or virtual machines, personal computers, laptops, handheld, portable and other computing devices and computing objects of all kinds including cell phones, tablet/slate computers, gaming/entertainment consoles and the like are contemplated for use in connection with various implementations including those exemplified herein. Accordingly, the general purpose computing mechanism described below with reference to FIG. 13 is but one example of a computing device.

In order to provide a context for the various aspects of the disclosed subject matter, FIG. 13 and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1320 (see below), non-volatile memory 1322 (see below), disk storage 1324 (see below), and memory storage 1346 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 13 illustrates a block diagram of a computing system 1300 operable to execute the disclosed systems and methods in accordance with an embodiment. Computer 1312, which can be, for example, part of the hardware of system 1320, includes a processing unit 1314, a system memory 1316, and a system bus 1318. System bus 1318 couples system components including, but not limited to, system memory 1316 to processing unit 1314. Processing unit 1314 can be any of various available processors. Dual microprocessors and other multiprocessor architectures also can be employed as processing unit 1314.

System bus 1318 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

System memory 1316 can include volatile memory 1320 and nonvolatile memory 1322. A basic input/output system (BIOS), containing routines to transfer information between elements within computer 1312, such as during start-up, can be stored in nonvolatile memory 1322. By way of illustration, and not limitation, nonvolatile memory 1322 can include ROM, PROM, EPROM, EEPROM, or flash memory. Volatile memory 1320 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 can also include removable/non-removable, volatile/non-volatile computer storage media. FIG. 13 illustrates, for example, disk storage 1324. Disk storage 1324 includes, but is not limited to, devices like a magnetic disk drive, floppy disk drive, tape drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to system bus 1318, a removable or non-removable interface is typically used, such as interface 1326.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 13 describes software that acts as an intermediary between users and computer resources described in suitable operating environment 1300. Such software includes an operating system 1328. Operating system 1328, which can be stored on disk storage 1324, acts to control and allocate resources of computer system 1312. System applications 1330 take advantage of the management of resources by operating system 1328 through program modules 1332 and program data 1334 stored either in system memory 1316 or on disk storage 1324. It is to be noted that the disclosed subject matter can be implemented with various operating systems or combinations of operating systems.

A user can enter commands or information into computer 1312 through input device(s) 1336. As an example, a mobile device and/or portable device can include a user interface embodied in a touch sensitive display panel allowing a user to interact with computer 1312. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1314 through system bus 1318 by way of interface port(s) 1338. Interface port(s) 1338 include, for example, a serial port, a parallel port, a game port, a universal serial bus (USB), an infrared port, a Bluetooth port, an IP port, or a logical port associated with a wireless service, etc. Output device(s) 1340 and a move use some of the same type of ports as input device(s) 1336.

Thus, for example, a USB port can be used to provide input to computer 1312 and to output information from computer 1312 to an output device 1340. Output adapter 1342 is provided to illustrate that there are some output devices 1340 like monitors, speakers, and printers, among other output devices 1340, which use special adapters. Output adapters 1342 include, by way of illustration and not limitation, video and sound cards that provide means of connection between output device 1340 and system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. Remote computer(s) 1344 can be a personal computer, a server, a router, a network PC, cloud storage, cloud service, a workstation, a microprocessor based appliance, a peer device, or other common network node and the like, and typically includes many or all of the elements described relative to computer 1312.

For purposes of brevity, only a memory storage device 1346 is illustrated with remote computer(s) 1344. Remote computer(s) 1344 is logically connected to computer 1312 through a network interface 1348 and then physically connected by way of communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1350 refer(s) to hardware/software employed to connect network interface 1348 to bus 1318. While communication connection 1350 is shown for illustrative clarity inside computer 1312, it can also be external to computer 1312. The hardware/software for connection to network interface 1348 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. user equipments do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

While the various embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope of the various embodiments.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the invention is not to be limited to any single implementation, but rather is to be construed in breadth, spirit and scope in accordance with the appended claims.

1. A method, comprising:
receiving, by a network device comprising a processor, user equipment capability information of a user equipment;
based on the user equipment capability information, determining, by the network device, that the user equipment is capable of operating as a local manager;
in response to the determining that the user equipment is capable of operating as the local manager, selecting, by the network device, the user equipment as the local manager;
communicating, by the network device, an indication to the user equipment that instructs the user equipment to operate as the local manager; and
communicating, by the network device, local manager data to the user equipment for use by the user equipment in operating as the local manager, wherein the local manager data comprises a list of access user equipment assigned to the local manager to manage.

2. The method of claim 1, further comprising, instructing, by the network device, the user equipment to measure reference signal data resulting in measured reference signal data, and to return a report corresponding to the measured reference signal data, and wherein the determining that the user equipment is capable of operating as the local manager further comprises receiving the report at the network device, and evaluating the report by the network device.

3. The method of claim 1, wherein the receiving the user equipment capability information comprises receiving at least one of: processing capability data of the user equipment, radio frequency capability data of the user equipment, a number of other user equipment that can be supported by the user equipment when operating as the local manager, power data of the user equipment, battery data of the user equipment, speed data of the user equipment, trajectory data of the user equipment, service availability data of the user equipment, or type data of the user equipment.

4. The method of claim 1, wherein the selecting the user equipment as the local manager comprises evaluating a selection criterion, the selection criterion is evaluated based on at least one of: a request of the user equipment to be the local manager, measurement data of the user equipment, a hardware capability of the user equipment, service availability data applicable to the user equipment, quality of service data applicable to user equipment, or user preference data.

5. The method of claim 1, wherein the communicating the indication to the user equipment that instructs the user equipment to operate as the local manager comprises instructing the user equipment to enter a local manager mode.

6. The method of claim 1, further comprises selecting, by the network device, an access user equipment of the list of access user equipment based on a type of communication traffic.

7. The method of claim 1, wherein the communicating the local manager data to the user equipment for use by the user equipment in operating as the local manager comprises assigning a radio resource pool to the user equipment for scheduling an access user equipment of the list of access user equipment.

8. The method of claim 1, further comprising, receiving, by the network device, communications from the user equipment, comprising receiving a data packet from an access user equipment of the list of access user equipment directed towards the network device, wherein the access user equipment is managed by the user equipment operating as the local manager.

9. The method of claim 1, further comprising, communicating, by the network device, an indication to the user equipment that instructs the user equipment to no longer operate as the local manager.

10. A radio user equipment device, comprising:
a processor; and
a memory that stores executable instructions that, when executed by the processor, facilitate performance of operations, the operations comprising:
connecting to a radio network device;
reporting capability information applicable to the radio user equipment device to the radio network device;
measuring reference signal data corresponding to local propagation and interference data;
reporting measurement data, based on the measuring the reference signal data, to the radio network device;
receiving an indication from the radio network device to operate the radio user equipment device as a local manager;
receiving local manager data from the radio network device, wherein the local manager data comprises a group of at least one access user equipment assigned to the local manager to manage; and
operating the radio user equipment device as the local manager, comprising communicating with an access user equipment of the group of at least one access user equipment, and relaying information received from the access user equipment to the radio network device.

11. The radio user equipment device of claim 10, wherein the operating the radio user equipment device as the local manager comprises broadcasting or unicasting data to the access user equipment.

12. The radio user equipment device of claim 10, wherein the operating the radio user equipment device as the local manager comprises scheduling radio resources to the access user equipment.

13. The radio user equipment device of claim 10, wherein the at least one access user equipment of the group of at least one access user equipment have a common quality of service requirement.

14. The radio user equipment device of claim 10, further comprising, relaying, based on a traffic type, by the user equipment operating as the local manager, one or more data packets between one access user equipment of the group of at least one access user equipment coupled to the user equipment operating as the local manager and another access user equipment of the group of at least one access user equipment coupled to the user equipment operating as the local manager.

15. The radio user equipment device of claim 10, further comprising, operating the user equipment operating as the local manager in a relay mode or a local breakout mode based on traffic type information.

16. A radio network device, comprising:
a processor; and
a memory that stores executable instructions that, when executed by the processor, facilitate performance of operations, the operations comprising:
selecting a user equipment as a local manager based on capability information of the user equipment and reference signal measurement data associated with the user equipment;
instructing the user equipment to operate as the local manager;
communicating data to the user equipment that identifies an comprises a group of access user equipment to be managed by the user equipment when operating as the local manager; and
receiving information from the user equipment comprising a data packet relayed by the user equipment from an access user equipment of the group of access user equipment.

17. The radio network device of claim 16, wherein the selecting the user equipment as the local manager comprises, receiving, from the user equipment the capability information of the user equipment and the reference signal measurement data associated with the user equipment, receiving from, other user equipment other than the user equipment, other capability information of the other user equipment and other reference signal measurement data associated with the other user equipment, and evaluating the capability information of the user equipment, the reference signal measurement data associated with the user equipment, the other capability information of the other user equipment, and the other reference signal measurement data associated with the other user equipment, to select the local manager.

18. The radio network device of claim 16, wherein the operations further comprises selecting the access user equipment of the group of access user equipment based on a quality of service requirement for communication traffic.

19. The radio network device of claim 16, wherein the operations further comprise, assigning a radio resource pool to the user equipment for scheduling the access user equipment.

20. The radio network device of claim 16, wherein the operations further comprise, assigning a hop order to the local manager for communication of data to a core network device coupled to the radio network device.
